(19) United States
(12) Patent Application Publication
(10) Pub. No.: US 2011/0148187 A1
(43) Pub. Date: Jun. 23, 2011

(54) Replaceable Track Pad and Mounting Plate

(76) Inventor: Scott Francis Lyons, LaVergne, TN (US)

(21) Appl. No.: 12/641,784

(22) Filed: Dec. 18, 2009

(51) Int. Cl. B62D 55/08; B62D 55/28

(52) U.S. Cl. 305/46; 305/189

(57) ABSTRACT

A replaceable track pad for use on a track chain of a crawler-type tracked machine reduces damage to a travel surface while providing traction and support to the tracked machine. The replaceable track pad includes a tread supported by a backing plate. The replaceable track pad may be mounted to a track link on a track chain using a mounting plate, forming a track pad mounting assembly. The mounting plate includes a substantially flat mounting surface. A worn or damaged track pad may be removed from the track chain without removing the mounting plate. The worn track pad can be refurbished by removing the worn tread material from the backing plate and attaching a new tread to the backing plate.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of the following patent application(s) which are hereby incorporated by reference: None

### BACKGROUND OF THE INVENTION

The present invention relates generally to a track shoe for a crawler-type tracked machine. More particularly, the present invention relates to a replaceable track pad and mounting plate forming a track pad assembly providing a tread for travel over a travel surface and for allowing replacement of a worn or damaged track pad from a track link. Additionally, the present invention relates to a method of refurbishing a worn track pad.

A conventional track, or grouser, shoe for use on a track chain of a crawler-type tracked machine typically includes a steel track shoe having metal projections extending outward from the track shoe away from the track chain. The metal projections extending from the track shoe generally provide traction required for track chain movement in soft surface materials, such as sand, gravel or dirt. Typically, in tracked machines, one conventional track shoe is bolted to each track link using one or more track bolts. A track bolt extends first through a hole in the track shoe and further through a hole in the track link where the track bolt engages a track nut on the inside surface of the track link.

Conventional track shoes are not well suited for travel on smooth, hard travel surfaces, like pavement, because the metal projections cause surface damage, including crushing and marking of the travel surface. Conventional track shoes also provide inadequate traction on hard, smooth surfaces as the metal projections tend to slide across the surface, thereby reducing machine efficiency and creating an unstable and dangerous situation, especially in wet conditions or when operating on an inclined surface.

Others have attempted to overcome the traction problems associated with operating crawler-type machinery on hard travel surfaces by placing pads on traditional metal track shoes. For example, U.S. Pat. No. 5,261,733 teaches an elastic material molded directly onto a conventional metal grouser shoe, creating a one-piece track pad. In a conventional one-piece track pad, the elastic material covers the metal projections and forms a relatively soft ground-engagement surface. The one-piece track pad is connected to a track link using a track bolt inserted through a clearance hole extending through the track pad and engaging a track nut. While conventional one-piece track pads are effective at preventing surface destruction and providing traction, they often become worn or damaged during use, requiring replacement. When a one-piece track pad becomes worn, the entire grouser shoe with integrally molded pad must be removed and replaced. The replacement process typically involves removing the track nut from the track bolt and detaching the one-piece track pad from the track link. However, during use, track nuts and track bolts often experience damaging wear and are exposed to corrosive elements, thereby rendering track nuts difficult to remove from track bolts using a wrench. Also, track bolt clearance and countersink holes positioned in the ground engagement surface of the tread can become filled with debris. As a result, a torch is typically used to cut corroded or damaged track bolts and track nuts from track links. The process of cutting track bolts and track nuts from track links for track pad replacement adds time to the track pad replacement process. The cutting process also creates waste by destroying track bolts and increases costs by requiring new replacement bolts or nuts to be installed with each new track pad.

Others have attempted to overcome the track pad replacement problems associated with prior art one-piece track shoes by creating two-piece track pads. Conventional two-piece track pads typically include a conventional track, or grouser, shoe that is first mounted to each track link using track bolts. The conventional track shoe is modified to include additional tread bolt clearance holes. A separate track pad component, made of a non-marking elastic material, is then secured to the conventional track shoe using tread bolts. The track pad typically includes a steel frame, or skeleton, with an elastic tread material molded around the frame. The frame is typically completely surrounded by tread material, and the frame extends over only a fraction of the tread footprint. The tread footprint is the surface area of the tread that engages the travel surface. Tread bolts extend through clearance holes on the grouser shoe and engage threaded regions or threaded track pad nuts on the frame, as generally described in U.S. Pat. No. 7,156,473. Alternatively, threaded tread bolt studs may extend outward from the frame to engage track pad nuts on the track shoe for securing the track pad in place, as generally described in U.S. Pat. No. 3,944,296. Using a two-piece prior art configuration, a track pad may be replaced after it becomes worn or damaged without removing the track bolts that hold the track shoe to the track link, allowing the steel track shoe to remain attached to the track chain. The two-piece configuration also reduces costs as the less expensive track pad can be replaced without replacing the track shoe and track bolts. This configuration protects tread bolts from excessive wear and corrosive materials on the travel surface. However, the steel frame typically only extends partially through the track pad, leaving regions of the track pad footprint unsupported by the steel frame. As a result, unsupported regions of the track pad have a tendency to experience accelerated wear as compared to fully supported tread regions. Accelerated wear at the tread edges, known in the art as chunking, significantly reduces track pad life. Additionally, unsupported regions may tear away completely, or separate, from the track pad, requiring track pad replacement and potentially causing damage to the travel surface as the metal regions of the track shoe become exposed. The prior art internal frame design also allows the entire track pad to flex during use, which further accelerates tearing, chunking and tread separation.

Generally, two types of track chain links are included on track chains, master links and standard links. Master links and standard links may have dissimilar track bolt hole patterns because master links include additional internal components for providing a releasable connection with adjacent standard links. Conventional grouser shoe track bolt clearance holes are generally configured for mounting to either a standard link or a master link. Conventional grouser shoes of the prior art generally do not allow one grouser shoe to be used on both standard and master links of track chains. Instead, one grouser shoe model having unique, master link specific track bolt clearance holes must be used on a master link; and a separate, standard grouser shoe model having standard link specific track bolt clearance holes must be used on a standard link. The prior art configuration requiring separate grouser shoe models for standard and master links increases expense and track chain complexity. The prior art two-piece configuration also requires different size grouser shoes for use on different size chains, further increasing the number of parts required for on-site track shoe replacement and complicating manufacturing, ordering of replacement parts and shipping.

Conventional two-piece track pads generally use a conventional grouser shoe mounted to a track link of a track chain. The prior art configuration typically includes extended regions shaped to fit between the metal protrusions that extend from the grouser shoe. In such a configuration, the overall thickness of the track pad equals the thickness of the track pad extending beyond the metal protrusions plus the thickness, or height, of the track shoe with metal protrusions. Once the track pad component is worn down to the edge of the metal protrusions, the track pad is no longer effective at preventing surface damage. Thus, the effective thickness of the track pad is the distance from the outer edge of the metal protrusions to the ground-engagement surface of the track pad. Additional track pad material molded between the metal protrusions of the grouser is wasted because the additional inter-projection material is not effective for preventing surface damage. In some crawler-type machines, for example a road surface milling machine, the height of the track from the road surface impacts the depth of cut. A thinner track pad reduces the height of the track from the travel surface and increases depth of cut. In many applications it is generally desirable to maximize depth of cut. However, it is also desirable to maximize track pad life. Track pad life is generally maximized by increasing the effective tread thickness. Thus, a track pad should maximize effective tread thickness and minimize overall track pad thickness to simultaneously optimize both depth of cut and track pad life. The prior art two-piece track pad configuration including metal protrusions extending from the track shoe has a relatively small effective tread thickness, leading to a sub-optimal track pad life.

Thus, there is a need in the art for a replaceable track pad that prevents damage to a travel surface, provides adequate surface traction, allows convenient replacement of worn or damaged track pads without requiring cutting or replacement of track bolts, and provides optimal track pad life by maximizing effective tread thickness for a desired track elevation. There is also a need in the art for a mounting plate for securing a track pad to a track chain that is configured to be interchangeably attached to a standard track link and a master track link. There is also a need in the art for a method of refurbishing worn replaceable track pads for allowing re-use of the backing plate.

### BRIEF SUMMARY OF THE INVENTION

The present invention includes a track pad mounting assembly for mounting onto a track link of a track chain on a tracked crawler-type machine. The track pad mounting assembly includes a replaceable track pad secured to a track link by a mounting plate. In one embodiment, the track pad can be replaced without removing the mounting plate. The track pad includes a tread made of a tread material. The tread material may include an elastic or resinous material, such as a rubber or a urethane. The tread is generally adapted for contacting the travel surface over which the tracked machine moves without causing excessive damage to the travel surface while providing traction. A rigid backing plate is secured to the tread. The backing plate can be attached to the mounting plate using track pad fasteners. In one embodiment, the track pad fasteners include tread bolts inserted through tread bolt clearance holes located in the mounting plate. The tread bolt clearance holes in the mounting plate can be positioned so the replaceable track pad can be mounted onto different size track chains. The backing plate includes a first pattern of track pad fastener connectors defined on the backing plate. In one embodiment, the track pad fastener connectors include threaded bores defined on the backing plate, so that each threaded bore may receive a track pad fastener for securing the backing plate to the mounting plate. In another embodiment, the track pad fastener connectors include threaded studs extending from the backing plate for receiving threaded nut fasteners. The backing plate includes a tread side attached to the tread and a mounting side shaped for attaching to the track pad attachment side of the mounting plate. The mounting side of the backing plate is substantially flat for attachment to a substantially flat mounting plate. The backing plate may include a chamfered region on a longitudinal edge for accommodating the structure of an adjacent track pad mounting assembly mounted on an adjacent track link.

In another embodiment, the present invention includes a replaceable track pad apparatus for attachment with a plurality of track pad fasteners to a mounting plate that is attached to a track link of a track with a plurality of mounting plate fasteners. The track pad apparatus comprises a backing plate having a substantially flat mounting side and a tread side. The backing plate includes a first pattern of fastener connectors defined on the mounting side for threadedly engaging the plurality of track pad fasteners to attach the backing plate to the mounting plate. In one embodiment, a second pattern of clearance recesses is open to the mounting side for providing clearance for the mounting plate fasteners so that the mounting side of the backing plate can flatly engage the mounting plate. The track pad also comprises a tread having a substantially uninterrupted ground engagement surface, and having a back surface co-extensive with and attached to the tread side of the backing plate.

In yet another embodiment, the backing plate of the track pad apparatus includes a first pattern of threaded bores open to the mounting side, each threaded bore being defined in the backing plate positioned entirely between the mounting side and the tread side of the backing plate. In another embodiment, the fastener connectors are threaded studs extending from the mounting side of the backing plate.

In one embodiment, the mounting plate of the present invention includes a track surface and a mounting surface. Both surfaces of the mounting plate are substantially flat. The track surface of the mounting plate is generally mounted to a track link on the track chain using one or more mounting plate fasteners. On a tracked machine, one mounting plate is generally secured to each link in a track chain. The mounting plate may also include one or more extended flanges for restricting mud and other debris from entering the spacing between track pads during machine operation or when a machine is stationary. The extended flange may include one or more notched recesses for allowing the chain to bend inward, or back-bend, during movement. The mounting plate also includes an outer pattern of clearance holes for attaching a track pad to the backing plate. In one embodiment, the mounting plate further comprises an inner pattern of mounting plate fastener clearance holes defined therein, each mounting plate fastener clearance hole extending from the track surface to the mounting surface and shaped for receiving a mounting plate fastener for securing the mounting plate to the track link. In another embodiment, the mounting plate further comprises at least one mounting plate fastener hole defining a countersink region for accommodating a mounting plate fastener so that the mounting plate fastener does not extend beyond the mounting surface of the mounting plate when the mounting plate is attached to the track link. In yet another embodiment, the mounting plate further comprises a plurality of threaded studs extending from the mounting side for attaching the mounting plate to the track link.

Another embodiment of the invention includes a track pad mounting assembly apparatus for mounting a replaceable track pad using track pad fasteners onto a mounting plate attached using mounting plate fasteners to a track link of a track on a crawler-type machine. The track pad mounting assembly apparatus comprises a mounting plate having a substantially flat track surface and a substantially flat mounting surface and including a substantially uniform mounting plate thickness extending between the track surface and the mounting surface. The mounting plate includes an outer pattern of track pad fastener clearance holes defined therein. The track pad mounting assembly apparatus also includes a replaceable track pad for attachment to the mounting surface of the mounting plate. The replaceable track pad of the track pad mounting assembly apparatus comprises a backing plate having a tread side and a substantially flat mounting side, the mounting side of the backing plate flatly engaging the mounting surface of the mounting plate. The replaceable track pad also includes a tread having a substantially uninterrupted ground engagement surface, and having a back surface co-extensive with and attached to the tread side of the backing plate.

In yet another embodiment, the present invention includes a method of refurbishing a worn track pad by providing a worn track pad apparatus comprising a backing plate having a mounting side and a tread side. The backing plate includes a first pattern of fastener connectors to attach the backing plate to the mounting plate. The worn track pad apparatus includes a worn tread made of a tread material. The tread has a worn ground engaging surface, and has a back surface at least partially co-extensive with and attached to the tread side of the backing plate. The method further includes the steps of removing the worn tread material from the backing plate and attaching a new tread to the backing plate, the new tread having a substantially uninterrupted ground engagement surface, and the new tread having a back surface co-extensive with and attached to the tread side of the backing plate.

In yet another embodiment, the present invention also includes a tread apparatus for use on a track pad for mounting to a track chain, the tread apparatus comprising a substantially rectangular block of tread material having a ground engaging surface and an opposing back surface, the surfaces being planar and the planes of the surfaces being substantially parallel to each other. The rectangular block includes a lateral edge oriented substantially perpendicular to the direction of track chain travel and a longitudinal edge oriented substantially parallel to the direction of track chain travel. The rectangular block of tread material also includes a perimeter surface extending between the ground engaging surface and the back surface and having an angle of orientation. The juncture of the perimeter surface and the ground engaging surface can be rounded at a first radius on the lateral edge of the rectangular block, and the juncture of the perimeter surface and the ground engaging surface can be rounded at a second radius on the longitudinal edge of the rectangular block, wherein the second radius is greater than the first radius.

Numerous objects, features and advantages of the present invention will be readily apparent to those skilled in the art, upon a reading of the following disclosure, when taken in conjunction with the accompanying drawings.

### BRIEF DESCRIPTION OF THE DRAWINGS

FIG. 1 illustrates a perspective view of a track pad mounting assembly in accordance with the present invention.

FIG. 2A illustrates a perspective view of a replaceable track pad in accordance with the present invention.

FIG. 2B illustrates a plan view of a backing plate in accordance with the present invention.

FIG. 3A illustrates a semi-exploded view of a track pad mounting assembly in accordance with the present invention.

FIG. 3B illustrates a semi-exploded view of the track pad mounting assembly of FIG. 3A.

FIG. 4 illustrates a semi-exploded view of the track pad mounting assembly of FIG. 1.

FIG. 5 illustrates an exploded view of a replaceable track pad in accordance with the present invention.

FIG. 6A illustrates a perspective view of a plurality of track pad mounting assemblies mounted on a track chain in accordance with the present invention.

FIG. 6B illustrates a cross-section view of a track pad mounting assembly in accordance with the present invention.

FIG. 7A illustrates a plan view of a mounting plate in accordance with the present invention.

FIG. 7B illustrates a detail view of the mounting plate of FIG. 7A.

FIG. 7C illustrates a plan view of a mounting plate in accordance with the present invention.

FIG. 7D illustrates a plan view of a mounting plate in accordance with the present invention.

FIG. 8A illustrates a side view of a mounting plate in accordance with the present invention.

FIG. 8B illustrates an elevation view of a track pad mounting assembly mounted on a track chain in accordance with the present invention.

FIG. 9A illustrates a detail perspective view of a backing plate in accordance with the present invention.

FIG. 9B illustrates a detail perspective view of a backing plate in accordance with the present invention.

FIG. 9C illustrates a perspective view of a backing plate in accordance with the present invention.

FIG. 9D illustrates an end view of a replaceable track pad in accordance with the present invention.

FIG. 9E illustrates a perspective view of a tread in accordance with the present invention.

FIG. 9F illustrates a perspective view of a backing plate in accordance with the present invention.

FIG. 9G illustrates a detail cross-section view of a replaceable track pad in accordance with the present invention.

FIG. 10A illustrates a top view of a tread in accordance with the present invention.

FIG. 10B illustrates a lateral side view of the tread of FIG. 10A.

FIG. 10C illustrates a longitudinal end view of a replaceable track pad in accordance with the present invention.

FIG. 11A illustrates a cross-section of one embodiment of a track pad mounting assembly in accordance with the present invention.

FIG. 11B illustrates a cross-section of one embodiment of a track pad mounting assembly in accordance with the present invention.

FIG. 11C illustrates a perspective view of one embodiment of a backing plate in accordance with the present invention.

FIG. 11D illustrates a side view of one embodiment of a replaceable track pad in accordance with the present invention.

FIG. 11E illustrates a side view of one embodiment of a track pad mounting assembly in accordance with the present invention.

FIG. 12A illustrates a cross-section of one embodiment of a track pad mounting assembly in accordance with the present invention.

FIG. 12B illustrates a cross-section of one embodiment of a track pad mounting assembly in accordance with the present invention.

FIG. 13A illustrates a perspective view of one embodiment of a mounting plate in accordance with the present invention.

FIG. 13B illustrates a side view of the mounting plate of FIG. 13A.

FIG. 13C illustrates a perspective view of the mounting plate of FIG. 13A.

FIG. 13D illustrates a cross-section of one embodiment of a track pad mounting assembly in accordance with the present invention.

FIG. 13E illustrates a cross-section of one embodiment of a track pad mounting assembly in accordance with the present invention.

FIG. 13F illustrates a side view of a track pad mounting assembly apparatus in accordance with the present invention.

### DETAILED DESCRIPTION OF THE INVENTION

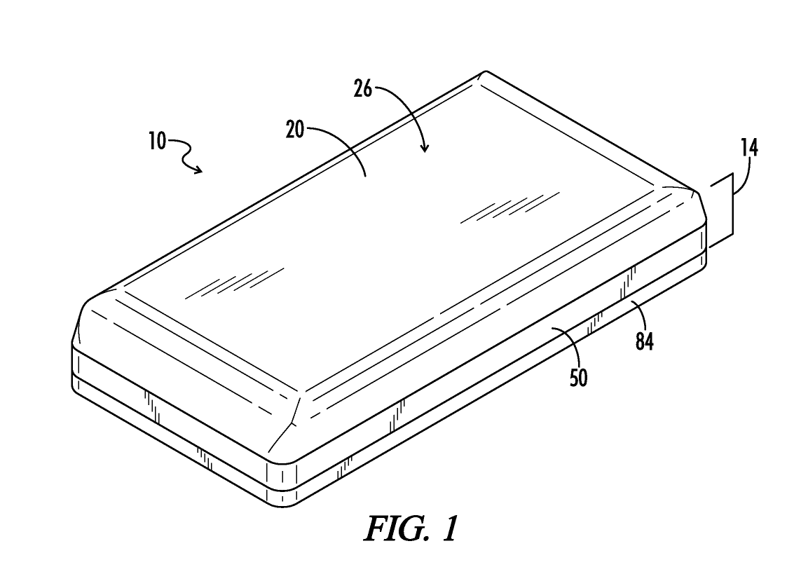

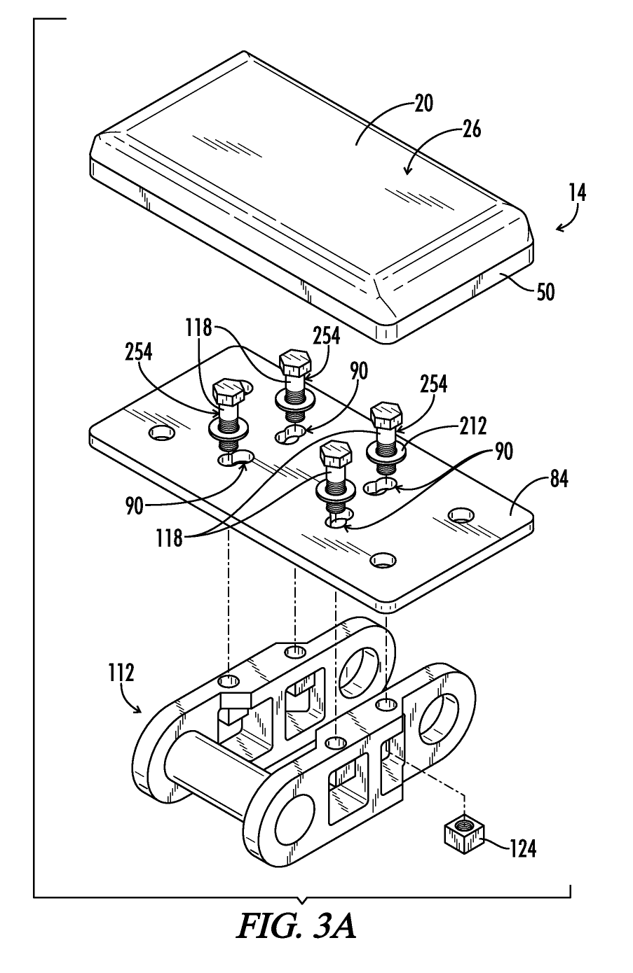

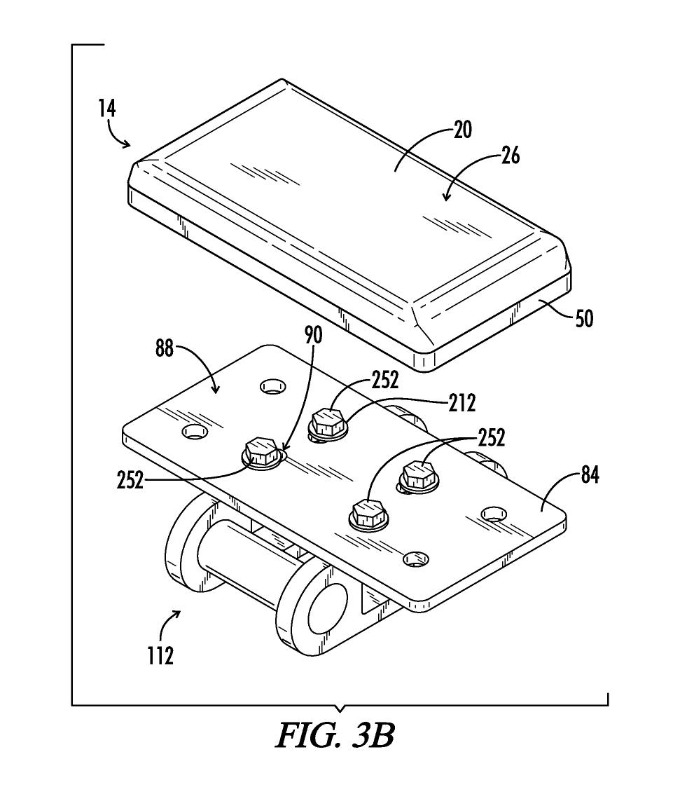

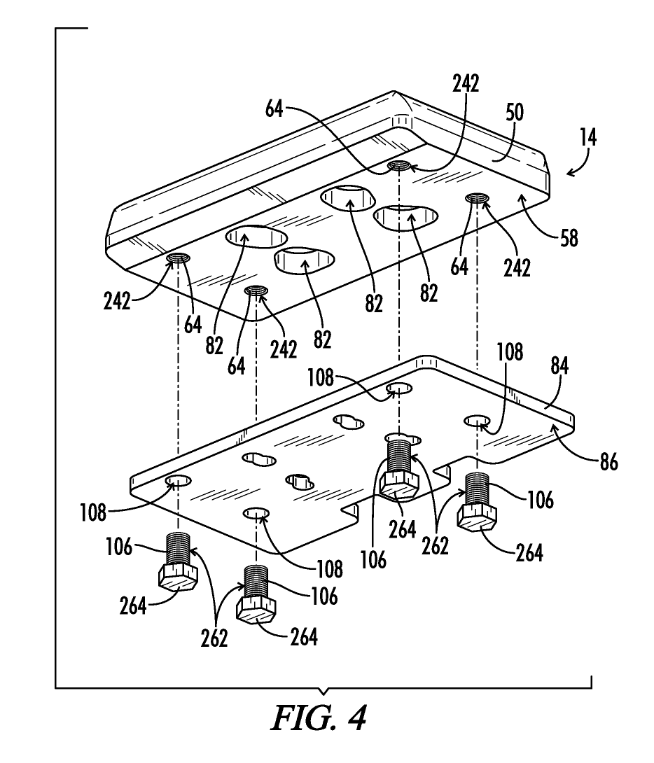

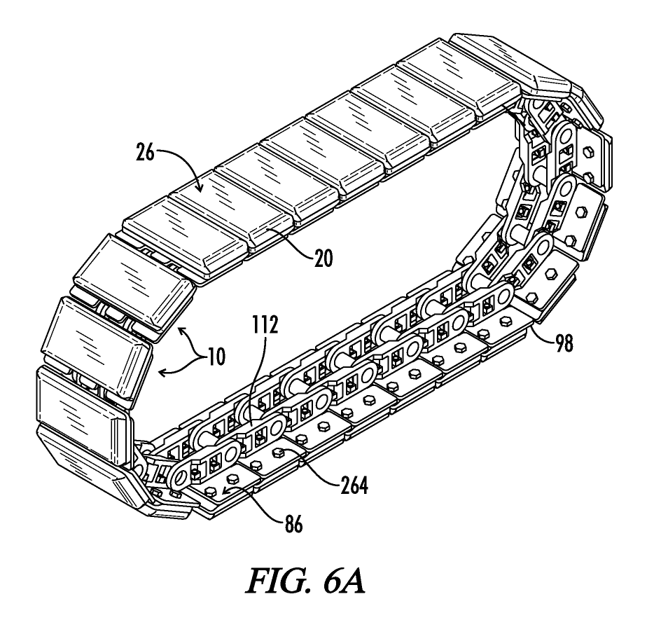

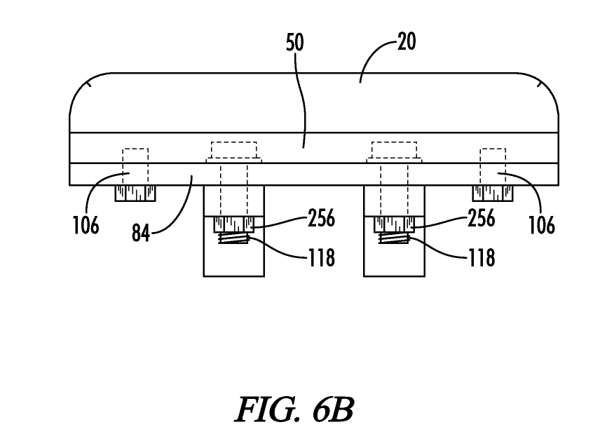

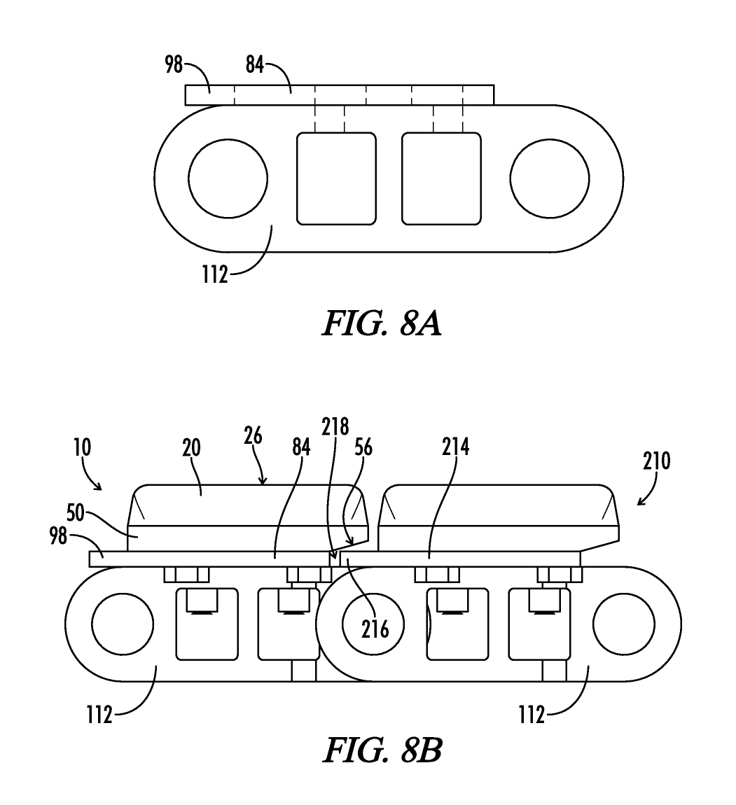

FIG. 1 generally illustrates a track pad mounting assembly 10 for use on a tracked machine in accordance with the present invention. The track pad mounting assembly 10 includes a replaceable track pad 14 attached to a mounting plate 84. The track pad mounting assembly 10 can be mounted to a track link 112 on a track chain of a tracked machine, as best seen in FIGS. 6A and 8B. The track pad mounting assembly 10 is generally formed by attaching the replaceable track pad 14 to the mounting plate 84 using one or more track pad fasteners 106, for example a tread bolt 262 shown in FIG. 4. The mounting plate 84 is generally secured to a track link 112 of a track chain using mounting plate fasteners 118, for example by track bolts 254 shown in FIG. 3A. In different embodiments, the mounting plate 84 may be attached to the track link 112 either before or after the track pad 14 is secured to the mounting plate 84. Generally, in one embodiment, the mounting plate 84 does not have to be removed from the track link 112 for the track pad 14 to be replaced.

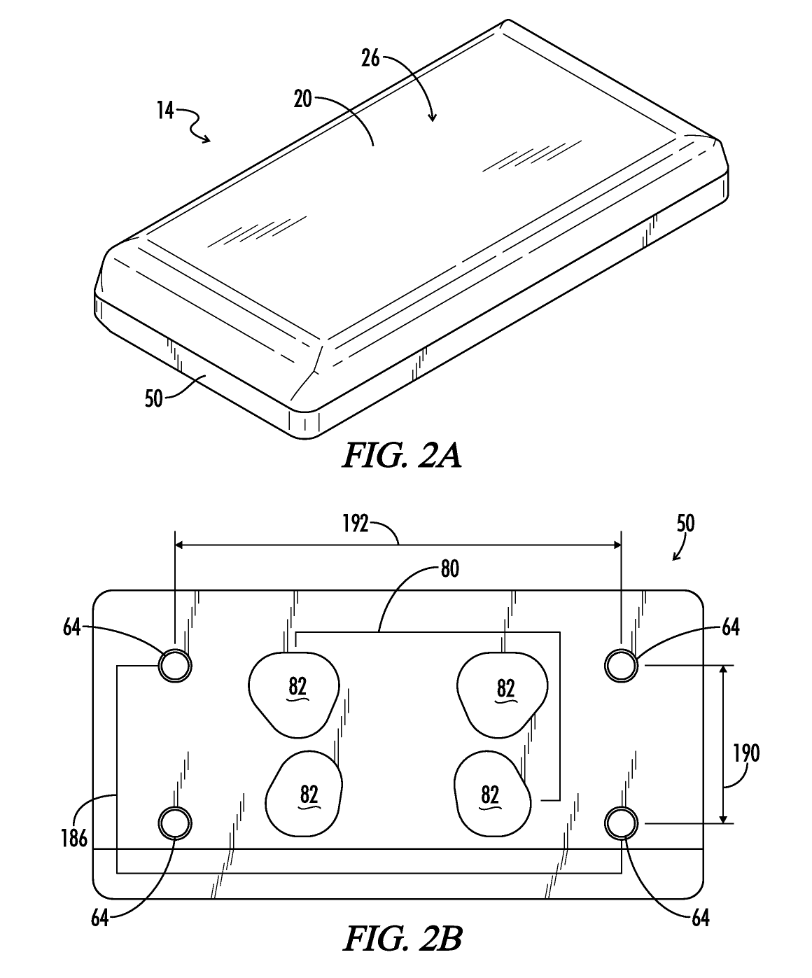

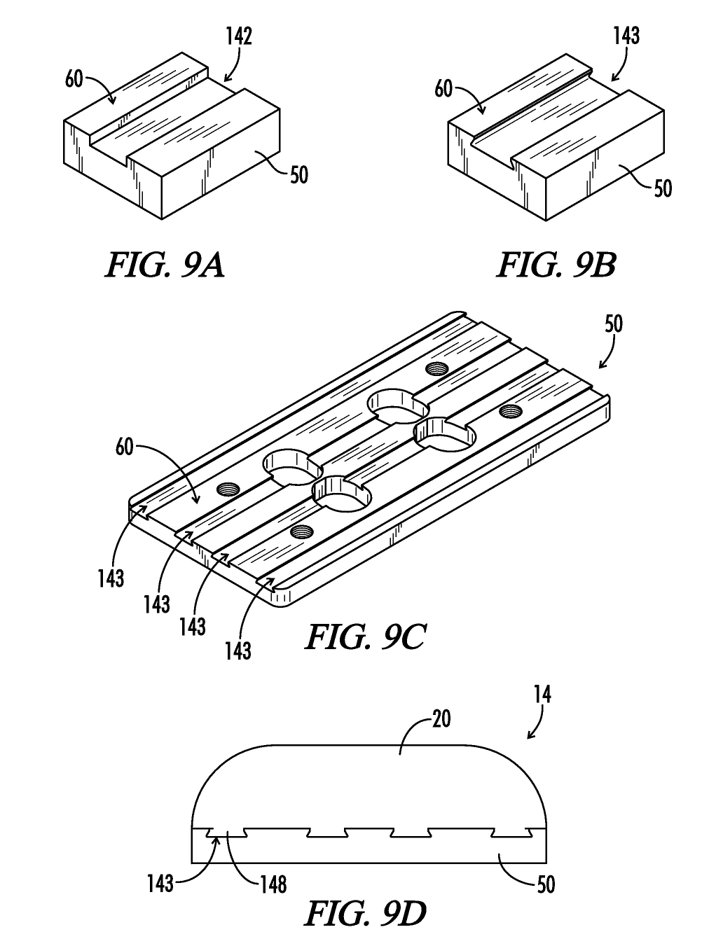

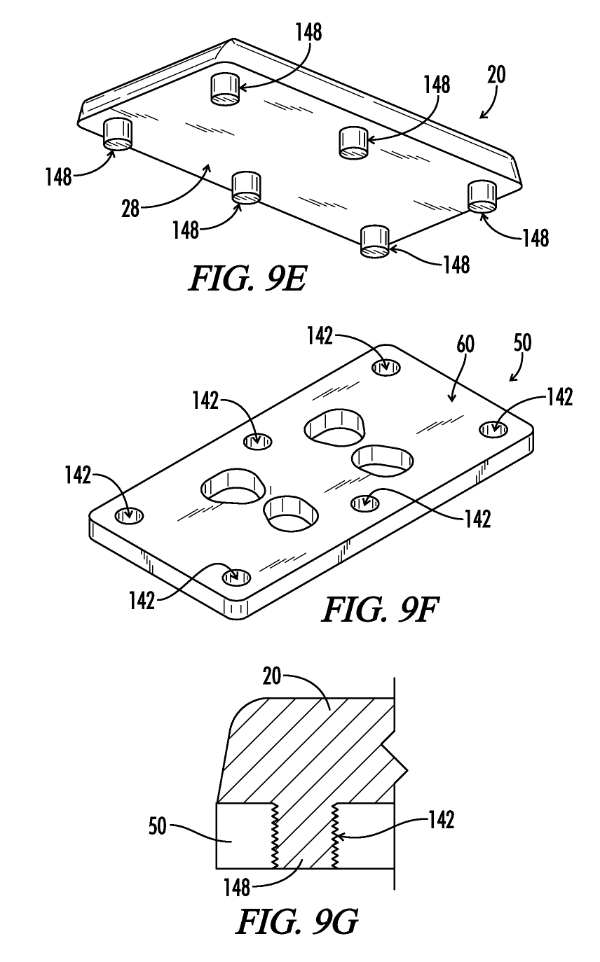

Referring now to FIG. 2A, the track pad 14 includes a tread 20 and a backing plate 50. The tread 20 is generally adapted for supporting the tracked machine on a travel surface over which the tracked machine travels. The tread 20 may include tread material comprising a rubber, a urethane, a polymer, another resinous or elastic material, or mixtures thereof. In one embodiment, the tread comprises a tread material having a Shore-A durometer hardness of between about 60 and about 99. In one embodiment, the tread material has a Shore-A durometer hardness of about 75. The tread 20 includes a ground engagement surface 26 and a back surface 28, shown in one embodiment in FIG. 9E. In one embodiment, the back surface 28 is planar and is attached to the tread side 60 of the backing plate 50 using a chemical adhesive. In another embodiment, the back surface 28 is planar and is directly molded to the tread side 60 of the backing plate 50 using a molding process wherein the tread 20 is positioned in contact with the backing plate 50 and heat or pressure, or both, are applied to the tread 20 or backing plate 50, or both, thereby causing the tread material to bond to and retain the shape of the tread side 60 of the backing plate 50. In one embodiment, the tread side 60 of the backing plate 50 undergoes surface preparation prior to direct molding of the tread 20 onto the backing plate 50 to ensure a proper molding bond between the tread 20 and the backing plate 50.

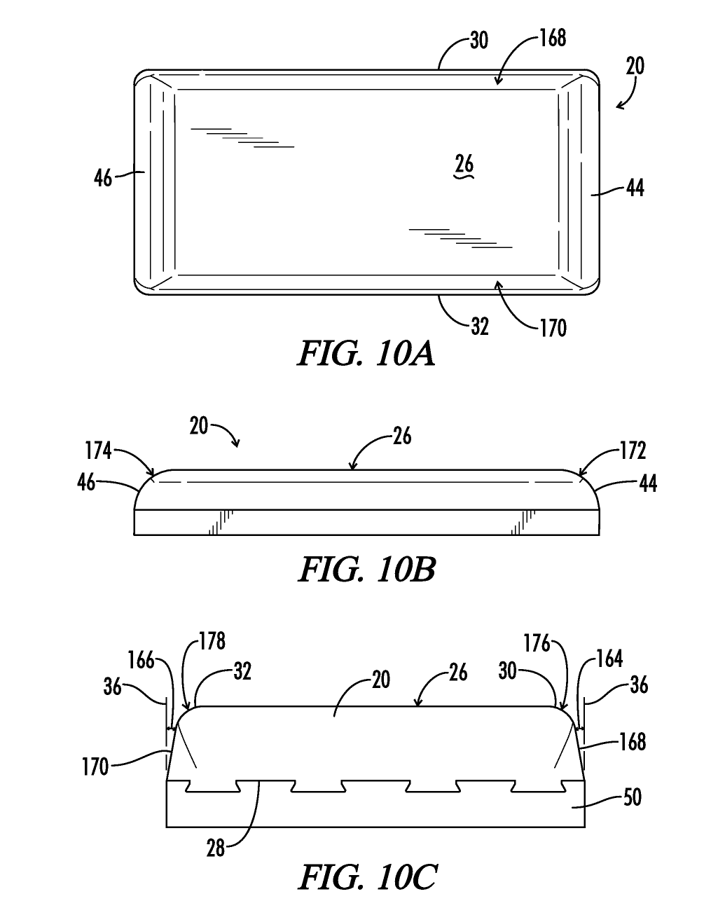

Referring now to FIG. 3A, in one embodiment, the ground engagement surface 26 is substantially uninterrupted and is substantially free from any openings. The tread 20 may also include a surface texture or tread pattern on the ground engagement surface 26, not shown. In one embodiment, the tread 20 includes a first lateral edge 30 and a second lateral edge 32, as seen in FIG. 10A. In one embodiment, the first and second lateral edges 30, 32 are oriented substantially perpendicular to the direction of local track chain travel. Each lateral edge 30, 32 of the tread 20 may be rounded. In one embodiment, each rounded lateral edge 30, 32 of the tread 20 defines a lateral edge radius 176, 178, as seen in FIG. 10C. The first lateral edge radius 176 and the second lateral edge radius 178 may be equal. In one embodiment, each lateral edge radius 176, 178 are substantially between 0.25 and 0.5 inches. Each lateral edge radius 176, 178 of the tread 20 can be optimized for maximizing the longitudinal footprint of the tread 20, thereby increasing stability of the tracked machine. The tread 20 also includes a first lateral surface 168 and a second lateral surface 170, as seen in FIG. 10A. In one embodiment, the first lateral surface 168 is oriented at a first angle 164 and the second lateral surface 170 is oriented at a second angle 166 relative to a vertical reference axis 36 oriented normal to the back surface 28 of the tread 20, as seen in FIG. 10C. In one embodiment, each angle 164, 166 extends substantially between five and twenty-five degrees. The ground engagement surface 26 of the tread 20 also includes a first longitudinal edge 44 and a second longitudinal edge 46. In one embodiment, each longitudinal edge 44, 46 may be oriented substantially parallel to the direction of local track chain travel. Each longitudinal edge 44, 46 of the tread 20 may be rounded, as seen in FIG. 10B. In one embodiment, the first longitudinal edge 44 defines a first longitudinal edge radius 172, and the second longitudinal edge 46 defines a second longitudinal edge radius 174. In one embodiment, each longitudinal edge radius 172, 174 are larger than each of the lateral edge radii 176, 178. In one embodiment, each longitudinal edge radius 172, 174 are substantially equal to one inch. In other embodiments, the lateral and longitudinal edges of the tread 20 may be shaped in angled, rectangular, or various other orientations. In one embodiment the tread 20 is a substantially rectangular block including a perimeter surface. The ground engagement surface 26 and the back surface 28 of the tread may be planar, wherein the planes of each surface 26, 28 are substantially parallel to each other. In one embodiment, the perimeter surface of the tread 20 includes an angle of orientation, wherein the angle of orientation is substantially 90 degrees relative to the back surface 28. In another embodiment, the juncture of the perimeter surface and the ground engagement surface 26 is rounded at a first radius on the lateral edge of the rectangular block and is rounded at a second radius on the longitudinal edge, wherein the second radius is greater than the first radius.

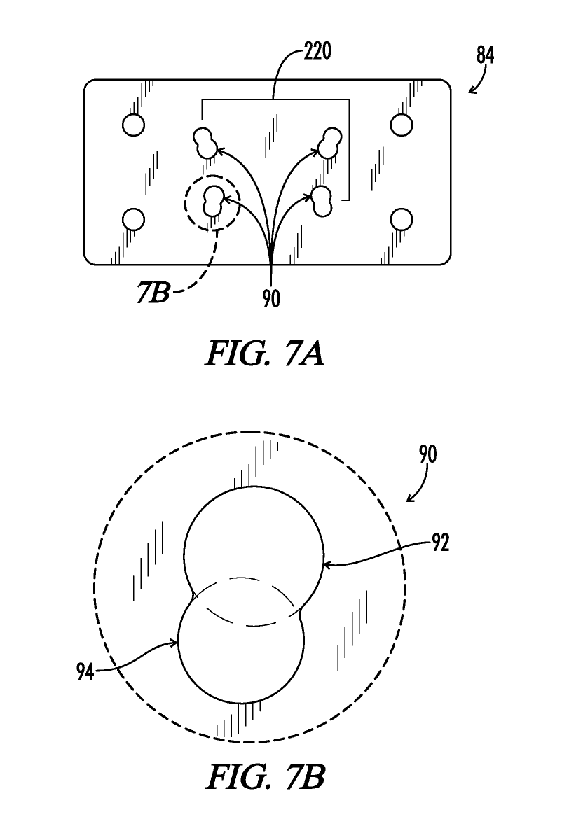

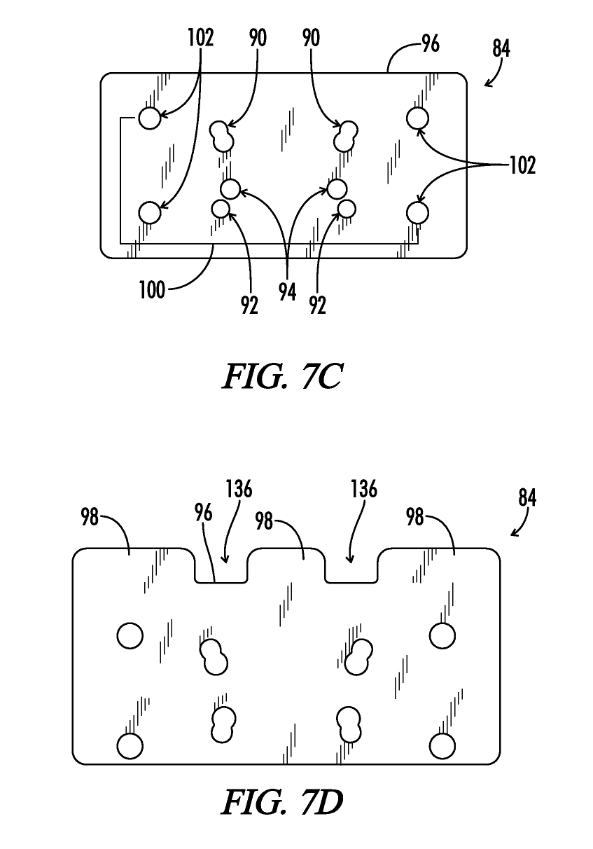

Referring now to FIG. 4, the mounting plate 84 generally includes a track surface 86 for mounting onto a track link 112 and a mounting surface 88 for receiving a track pad 14, as seen in FIG. 3B. The mounting plate 84 is generally attached to a track link 112 using one or more mounting plate fasteners 118, seen in FIGS. 3A and 3B. Mounting plate fasteners 118 may have several different embodiments in accordance with the present invention. Referring to FIG. 3A, one embodiment of a mounting plate 84 using mounting plate fasteners 118 to secure the mounting plate 84 to a track link 112 is shown. In this embodiment, the mounting plate fasteners 118 are track bolts 254. In this embodiment, each mounting plate fastener 118 is inserted through a mounting plate fastener clearance hole 90 located in the mounting plate 84. The mounting plate fastener clearance holes 90 are arranged in an inner pattern 220, seen in FIG. 7A. In one embodiment, each mounting plate fastener clearance hole 90 may have a circular or non-circular shape for accommodating a track bolt 254.

A track chain generally includes a plurality of standard track links and at least one master track link. The master track link allows the track chain to be separated for installation or removal from the tracked machine. Standard track links and master track links typically include different hole patterns for receiving mounting plate fasteners 118. Also, standard track bolts and master track bolts may have different bolt diameters. In one embodiment, shown in FIG. 7A, the inner pattern 220 of mounting plate fastener clearance holes 90 on the mounting plate 84 is adapted for interchangeably securing a mounting plate 84 onto a standard track link or a master track link by interchangeably accepting standard or master track bolts. In one embodiment, shown in FIG. 7B, a mounting plate fastener clearance hole 90 of a mounting plate 84 includes a standard track bolt clearance hole 92 overlapping with a non-concentric master track bolt clearance hole 94. In other embodiments, the standard and master track bolt clearance holes 92, 94 of the inner pattern 220 form independent, non-overlapping holes, as seen in FIG. 7C.

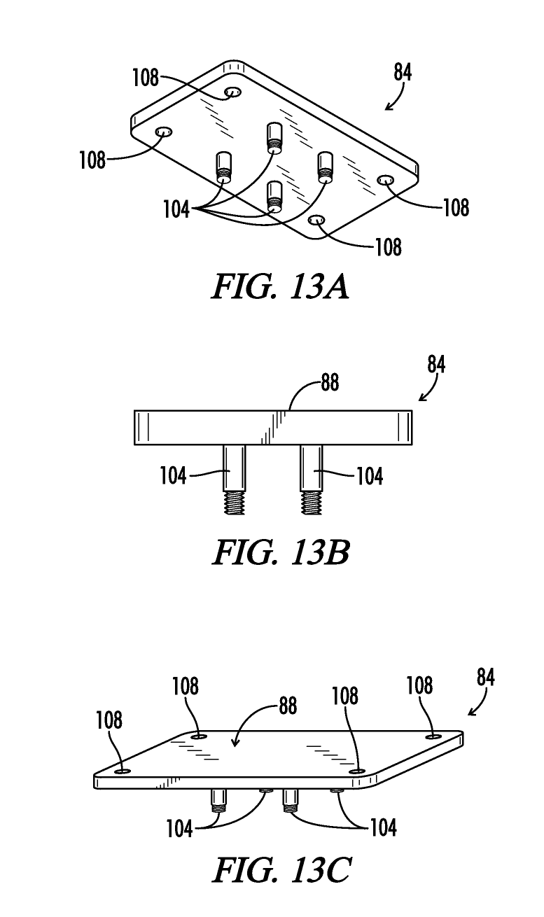

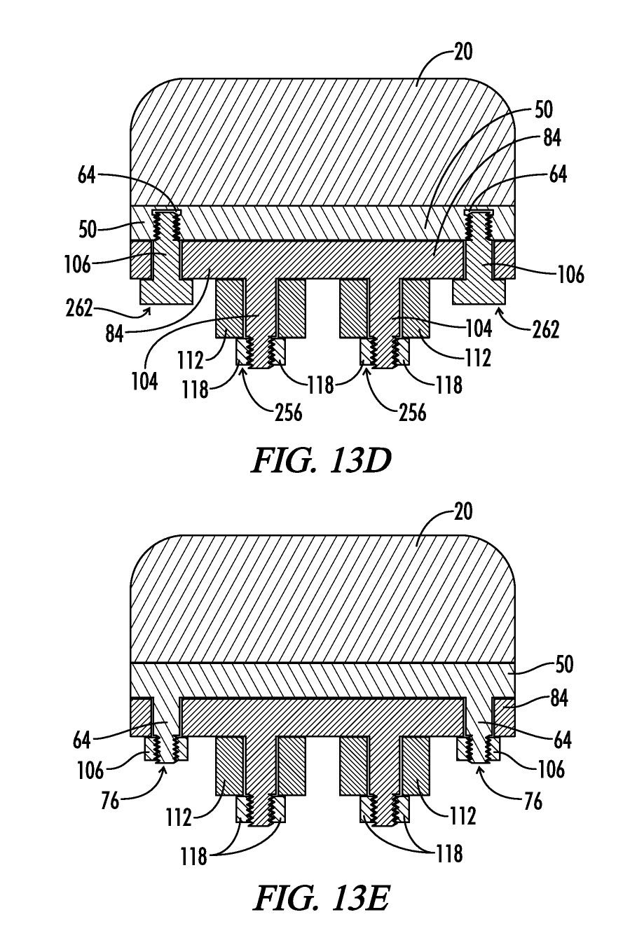

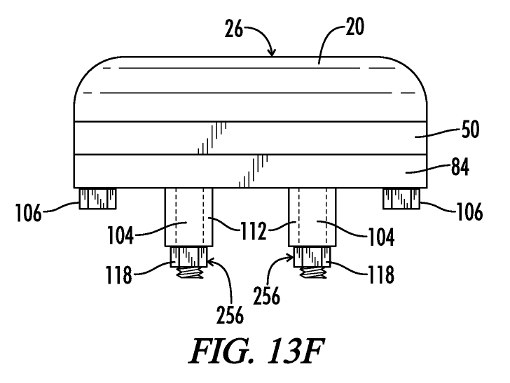

In another embodiment, show in FIGS. 13A, 13B, and 13C, the mounting plate includes a plurality of threaded studs 104 extending from the track surface 86. In this embodiment, mounting plate fasteners 118 comprise threaded track nuts 256 that engage the threaded studs 104 to secure the mounting plate 84 to the track link, as seen in FIGS. 6B, 13D and 13F. Other embodiments in accordance with the present invention include various other types of mounting plate fasteners 118 not shown for securing the mounting plate 84 to the track link 112.

Referring again to FIG. 3A, in one embodiment the mounting plate fasteners 118 are track bolts 254. In this embodiment, each track bolt 254 includes a track bolt head 252, as seen in FIG. 3B. In the one embodiment shown in FIG. 3B, each track bolt head 252 protrudes above the mounting surface 88 of the mounting plate 84 when the mounting plate 84 is secured to the track link 112. Additionally, a washer 212 may be positioned between the track bolt head 252 and the mounting surface 88 of the mounting plate 84. In other embodiments, a mounting plate fastener clearance hole 90 may include an elongated slot, not shown.

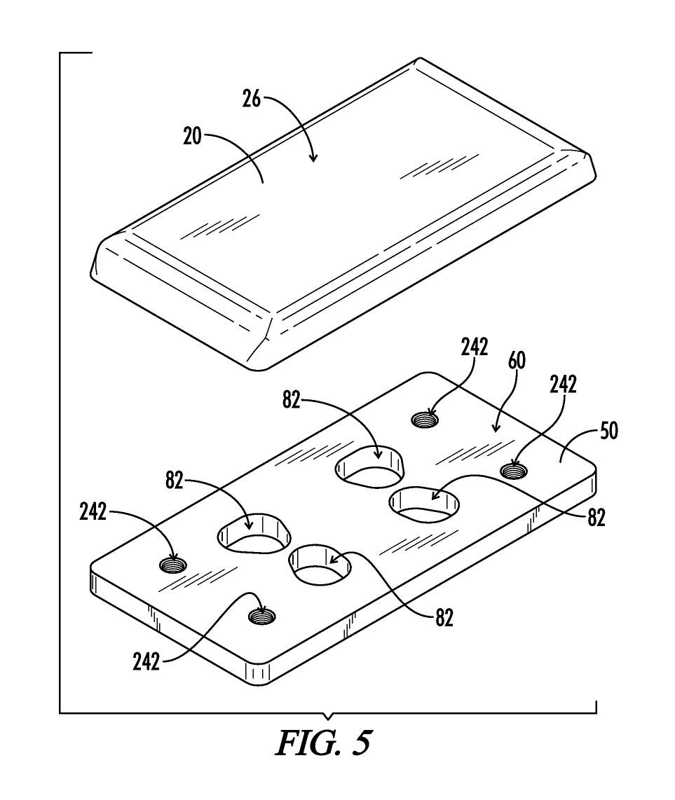

In the embodiment shown in FIG. 3B, a replaceable track pad 14 can be attached to the mounting surface 88 of the mounting plate 84. The replaceable track pad 14 includes a backing plate 50 and a tread 20. The backing plate 50 includes a mounting side 58 for engaging the mounting surface 88 of the mounting plate 84, seen in FIG. 4. The mounting side 58 of the backing plate 50 is substantially flat for flatly engaging the mounting surface 88 of the mounting plate 84. Referring now to FIG. 3B and FIG. 4 simultaneously, the backing plate 50 may, in one embodiment, include one or more clearance recesses 82, each clearance recess 82 being shaped for accommodating a track bolt head 252 when the backing plate 50 is attached to the mounting plate 84. Each clearance recess 82 may extend only partially through the backing plate 50, or may extend completely through the backing plate 50 as seen in FIG. 5. In one embodiment, the clearance recesses 82 form a second pattern 80 on the backing plate 50, shown in FIG. 2B. In one embodiment, the second pattern 80 is substantially rectangular. The clearance recesses 82 are generally open to the mounting side 58 of the backing plate 50.

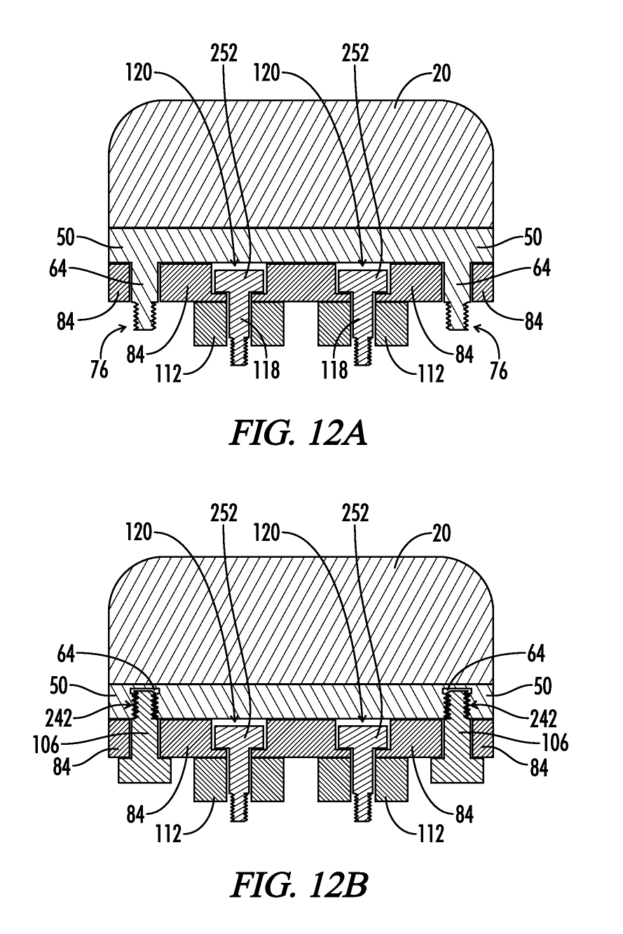

In another embodiment, no clearance recesses 82 are present on the backing plate 50. In one embodiment, shown in FIGS. 12A and 12B, the backing plate 50 does not include clearance recesses 82 for accommodating track bolt heads 252. In this embodiment, the mounting side 58 of the backing plate 50 can flatly engage the mounting surface 88 of the mounting plate 84 because each mounting plate fastener clearance hole 90 includes a countersunk region 120. In this embodiment, each track bolt head 252 fits in the countersunk region 120 so the backing plate 50 flatly engages the mounting plate 84. In one embodiment, a mounting plate 84 having mounting plate fastener clearance holes 90 with countersunk regions 120 can be used to mount a backing plate 50 having threaded bores 242 as fastener connectors 64, shown in FIG. 12B. In another embodiment, a mounting plate 84 having mounting plate fastener clearance holes 90 with countersunk regions 120 can be mounted to a backing plate 50 having track pad mounting studs 76 as fastener connectors 64, shown in FIG. 12B. In other embodiments not show, both a countersunk regions 120 and clearance recesses 82 can be used to allow the backing plate 50 to flatly engage a mounting plate 84.

Referring again to FIG. 4, in one embodiment in accordance with the present invention, the replaceable track pad 14 can be secured to a mounting plate 84 using track pad fasteners 106. Each track pad fastener 106 generally engages a fastener connector 64 located on the backing plate 50 for securing the track pad 14 to the mounting plate 84.

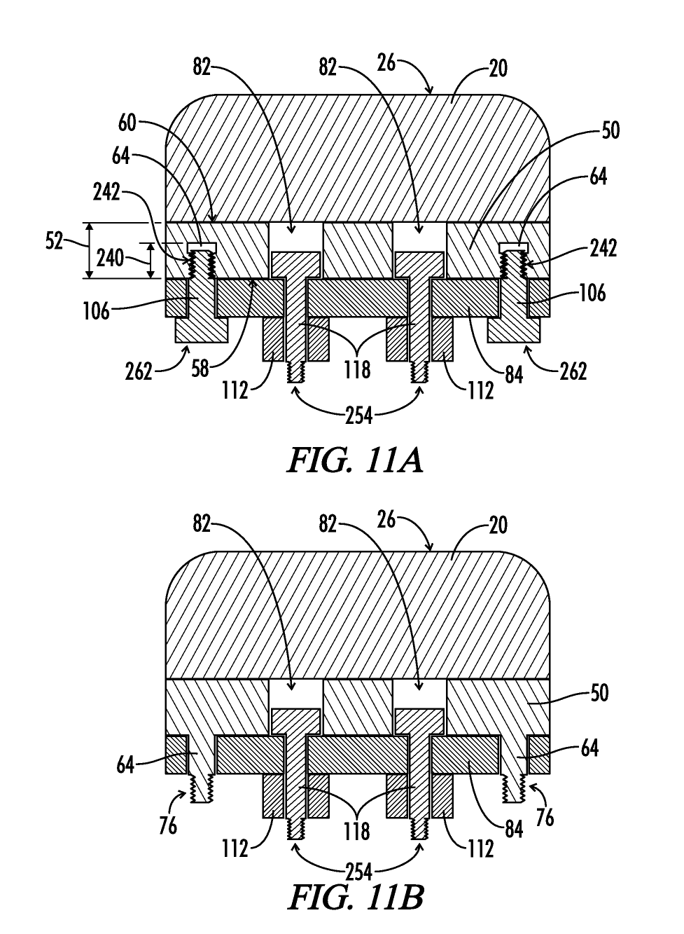

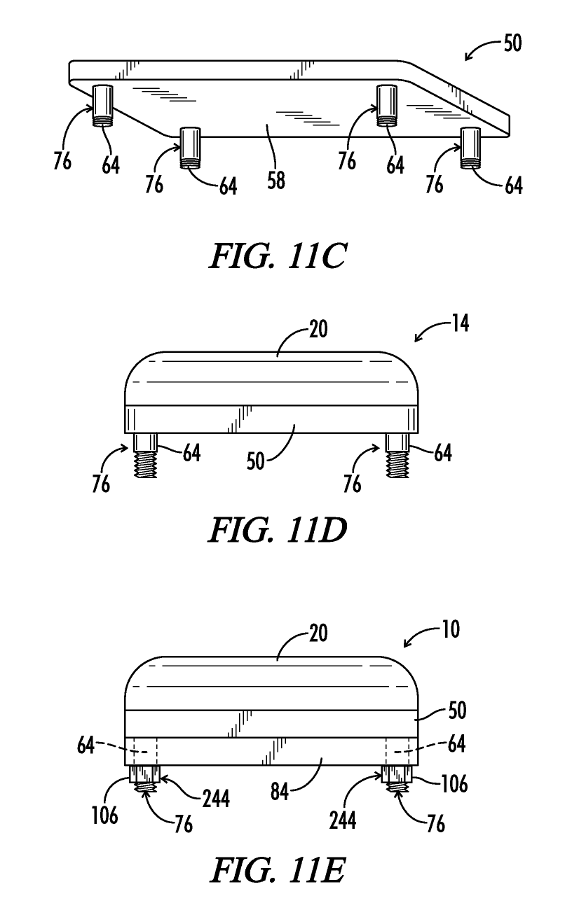

In the embodiment shown in FIG. 4, each track pad fastener 106 comprises a tread bolt 262. Each tread bolt 262 may include a tread bolt head 264. In one embodiment, each tread bolt 262 is inserted through a track pad fastener clearance hole 108 in the mounting plate 84. Also shown in FIG. 4, one embodiment of a fastener connector 64 includes a threaded bore 242. Each threaded bore 242 is open to the mounting side 58 of the backing plate for receiving a track pad fastener 106. Also, each threaded bore 242 is positioned entirely between the mounting side 58 and the tread side 60 of the backing plate 50, as seen in FIG. 11A. The threaded bore 242 extends into the backing plate 50 from the mounting side 58. The threaded bore 242 includes a threaded bore depth 240. The threaded bore depth 240 may be less than the backing plate thickness so that the threaded bore 242 does not extend completely through the backing plate 50, but rather forms a blind threaded bore 242 extending into the backing plate 50 from the mounting side 58, as seen in FIG. 11A. In another embodiment, shown in FIG. 5, a threaded bore 242 extends completely through the backing plate 50 to form a void extending from the mounting side 58 of the backing plate 50 to the tread side 60 of the backing plate 50. In one embodiment, only part of the threaded bore 242 is threaded. As seen in FIG. 11A, in one embodiment, the threaded bore 242 is machined into the backing plate 50. In one embodiment, both blind and through threaded bores 242 are included on the same backing plate 50, not shown.

In another embodiment, shown in FIGS. 11B and 11C, the fastener connector 64 defined on the mounting side 58 of the backing plate 50 comprises one or more track pad mounting studs 76 protruding from the mounting side 58. As seen in FIG. 11D, each track pad mounting stud 76 includes a threaded region for engaging a track pad fastener 106, as seen in FIG. 11E. In the embodiment shown in FIG. 11E, each track pad fastener 106 is a threaded nut 244. In the embodiments shown in FIGS. 11C, 11D and 11E, each track pad mounting stud 76 can extend through a clearance hole 108 on the mounting plate 84 to secure the replaceable track pad 14 to the mounting plate 84.

In one embodiment, shown in FIG. 2B, the first pattern 186 of fastener connectors 64 is rectangular. The first pattern 186 includes a first pattern longitudinal dimension 190 and a first pattern lateral dimension 192. In one embodiment, the first pattern longitudinal dimension 190 ranges from about 1.5 to about 4.5 inches on center and the first pattern lateral dimension 192 ranges from about 7 to about 10 inches on center. In another embodiment, the first pattern longitudinal dimension 190 is about 3.0 inches on center and the first pattern lateral dimension 192 is about 8.5 inches on center. Each fastener connector 64 is aligned coaxially with a clearance hole 108 located on the mounting plate 84, as seen in FIG. 4. Generally, in one embodiment each fastener connector 64 may be disengaged from the track pad assembly 10 to allow removal of the track pad 14 from the mounting plate 84 without removing a mounting plate fastener 118.

Referring now to FIG. 9A, a detail view of a section of a backing plate 50 in accordance with the present invention is generally shown. In one embodiment, the backing plate 50 includes a tread-binding recess 142 defined in the tread side 60 of the backing plate 50. In one embodiment, the tread-binding recess 142 includes a rectangular cross-section, as seen in FIG. 9A. Other embodiments may include a tread-binding recess 142 having various other cross-sectional shapes. In one embodiment, the tread side 60 of the backing plate 50 includes a dovetail groove 143, as seen in FIG. 9B. In one embodiment, multiple dovetail grooves 143 are located on the backing plate 50, as seen in FIG. 9C. A tread-binding recess 142, shown in FIG. 9A or a dovetail groove shown in FIG. 9B may extend along either the lateral or longitudinal direction of the backing plate 50 or may be angled across the tread side 60 of the backing plate 50. Referring now to FIG. 9D, a track pad 14 in accordance with the present invention is shown. The track pad 14 includes a tread 20 secured to a backing plate 50. The tread 20 extends into and is coextensive with a plurality of dovetail grooves 143, as seen in FIG. 9D. In one embodiment, the tread 20 includes one or more extended regions 148, each extended region 148 shaped to fit in a tread-binding recess 142 or dovetailed groove 143 on the backing plate 50. In one embodiment, each extended region 148 is molded into a tread-binding recess 142 or dovetail groove 143, thereby filling the tread-binding recess 142 or dovetail groove 143 with tread material. In one embodiment, each tread-binding recess 142 is cylindrical, as seen in FIG. 9F. In this embodiment, the tread 20 includes extended regions 148 shaped for engaging the cylindrical tread-binding recesses 142, as seen in FIG. 9E. In another embodiment, a cylindrical tread-binding recess 142 may be threaded, as seen in FIG. 9G.

Referring to FIG. 7C, in one embodiment, one replaceable track pad 14 can be used with a variety of similar track chain sizes based on both the outer pattern 100 of track pad clearance holes 102 on the mounting plate 84 and the dimensions of the first pattern 186 of fastener connectors 64 on the backing plate 50, also seen in FIG. 2B. In one embodiment, the lateral dimension 192 of the first pattern 186 is defined by the smallest distance that will fit outside the width of the widest track chain to be accommodated. In one embodiment, the longitudinal dimension 190 of the first pattern 186 is defined by the longest distance that will fit between link pins of the smallest track link 112 and allow for centering the backing plate 50 on the track link 112, as seen in FIG. 8B.

In one embodiment, the mounting plate 84 includes one or more extended flanges 98 protruding from a lateral edge 96 of the mounting plate 84, as seen in FIG. 7D. The extended flange 98 of the mounting plate 84 may include one or more notched recesses 136. In one embodiment, each notched recess 136 is shaped for accommodating a track chain link during movement of the track chain around an idler or during back-bending movement of the track chain. In one embodiment, the extended flange 98 of the mounting plate 84 may restrict mud and other debris from entering the regions between adjacent track pads during movement of the tracked machine or while the tracked machine is at rest, as is seen generally in FIG. 6A.

Referring now to FIG. 8A, in one embodiment, the mounting plate 84 is first attached to a track link 112. Next, the track pad 14, including the backing plate 50 and the tread 20, is attached to the mounting plate 84 to form a track pad mounting assembly 10, seen in FIG. 8B. The mounting plate 84 may include a first extended flange 98. A second track pad assembly 210 is attached to an adjacent track link 112. In one embodiment, a second extended flange 216 extends from the second mounting plate 214, defining a gap 218 between the first and second mounting plates 84, 214. In one embodiment, the backing plate 50 may include a chamfered region 56 to allow clearance of the second extended flange 216 on the second mounting plate 214 during movement of the track links 112 around a curved region on the track chain drive path or during back bending of the track chain.

Thus, although there have been described particular embodiments of the present invention of a new and useful replaceable track pad, track pad mounting assembly, tread apparatus, mounting plate, and method for refurbishing a worn track pad, it is not intended that such references be construed as limitations upon the scope of this invention except as set forth in the following claims.

What is claimed is:

1. A replaceable track pad apparatus for attachment with a plurality of track pad fasteners to a mounting plate attached to a track link of a track with a plurality of mounting plate fasteners, the track pad apparatus comprising:
a backing plate having a substantially flat mounting side and a tread side, the backing plate including:
a first pattern of fastener connectors defined on the mounting side for threadedly engaging the plurality of track pad fasteners to attach the backing plate to the mounting plate; and
a second pattern of clearance recesses open to the mounting side for providing clearance for the mounting plate fasteners so that the mounting side of the backing plate can flatly engage the mounting plate; and
a tread having a substantially uninterrupted ground engagement surface, and having a back surface co-extensive with and attached to the tread side of the backing plate.

2. The apparatus of claim 1, wherein:
each of the fastener connectors of the backing plate comprise a threaded bore defined in the backing plate, each threaded bore positioned entirely between the tread side and the mounting side, each threaded bore open to the mounting side for receiving the track pad fastener; and
the track pad fastener comprising a threaded tread bolt shaped for threadedly engaging the threaded bore for securing the track pad apparatus to the mounting plate.

3. The apparatus of claim 2, wherein:
the backing plate having a substantially uniform backing plate thickness defined by the distance between the tread side and the mounting side;
each threaded bore defining a threaded bore depth extending into the backing plate beginning at the mounting side; and
each threaded bore depth extending into the backing plate less than the backing plate thickness.

4. The apparatus of claim 1, wherein:
each of the fastener connectors of the backing plate comprise a threaded track pad mounting stud extending from the mounting side of the backing plate;
the tread surface of the backing plate being substantially flat; and
the track pad fastener comprises a threaded nut for threadedly engaging the threaded region of the track pad mounting stud for securing the replaceable track pad apparatus to the mounting plate.

5. The apparatus of claim 1, wherein each of the clearance recesses is non-circular.

6. The apparatus of claim 1, wherein the tread side of the backing plate is substantially planar.

7. The apparatus of claim 1, wherein the first pattern comprises a first rectangular pattern having a first pattern lateral dimension in the range of from about 7 to about 10 inches on center and a first pattern longitudinal dimension in the range of from about 1.5 to about 4.5 inches on center.

8. The apparatus of claim 7, wherein the first pattern lateral dimension is about 8.5 inches on center and the first pattern longitudinal dimension is about 3.0 inches on center.

9. The apparatus of claim 1, wherein:
the tread side of the backing plate includes one or more tread-binding recesses defined therein, and the tread extends into and is co-extensive with the one or more tread-binding recesses.

10. The apparatus of claim 9, wherein the tread-binding recesses are cylindrical holes.

11. The apparatus of claim 10, wherein the cylindrical holes are threaded.

12. The apparatus of claim 1, wherein the tread side of the backing plate includes one or more dovetail grooves defined therein, and the tread extends into and is coextensive with the one or more dovetail grooves.

13. The apparatus of claim 1, wherein the tread comprises a tread material having a Shore-A durometer hardness of between about 60 and about 99.

14. The apparatus of claim 1, wherein:
the back surface of the tread is planar;
the tread side of the backing plate is planar; and
the back surface of the tread is secured to the tread side of the backing plate with an adhesive.

15. The apparatus of claim 1, wherein the tread is molded directly to the tread side of the backing plate.

16. The apparatus of claim 1, further comprising the backing plate including a chamfered longitudinal edge.

17. A replaceable track pad apparatus for attachment with a plurality of track pad fasteners onto a mounting plate attached with a plurality of mounting plate fasteners to a track link of a track on a crawler-type machine, the track pad apparatus comprising:
a backing plate having a substantially flat exposed mounting side and a tread side, the backing plate including a first pattern of threaded bores open to the mounting side, each threaded bore being defined in the backing plate positioned entirely between the mounting side and the tread side of the backing plate; and
a tread having a substantially uninterrupted ground engagement surface, and having a back surface co-extensive with and attached to the tread side of the backing plate.

18. A track pad mounting assembly apparatus for mounting a replaceable track pad using track pad fasteners onto a mounting plate attached using mounting plate fasteners to a track link of a track on a crawler-type machine, the apparatus comprising:
a mounting plate having a substantially flat track surface and a substantially flat mounting surface and including a substantially uniform mounting plate thickness extending between the track surface and the mounting surface, the mounting plate including an outer pattern of track pad fastener clearance holes defined therein; and
a replaceable track pad for attachment to the mounting surface of the mounting plate, comprising:
a backing plate having a tread side and a substantially flat mounting side, the mounting side of the backing plate flatly engaging the mounting surface of the mounting plate; and
a tread having a substantially uninterrupted ground engagement surface, and having a back surface co-extensive with and attached to the tread side of the backing plate.

19. The apparatus of claim 18, wherein:
the mounting plate further comprises an inner pattern of mounting plate fastener clearance holes defined therein, each mounting plate fastener clearance hole extending from the track surface to the mounting surface and shaped for receiving a mounting plate fastener for securing the mounting plate to the track link.

20. The apparatus of claim 19, wherein:
the mounting plate further comprising at least one mounting plate fastener clearance hole defining a countersink region for accommodating a mounting plate fastener so that the mounting plate fastener does not extend beyond the mounting surface of the mounting plate when the mounting plate is attached to the track link.

21. The apparatus of claim 18, wherein:
the mounting plate further comprises a plurality of threaded studs extending from the mounting side for attaching the mounting plate to the track link.
